(19) United States
(12) Patent Application Publication
(10) Pub. No.: US 2017/0064635 A1
(43) Pub. Date: Mar. 2, 2017

(54) POWER TRANSMISSION APPARATUS AND METHOD FOR CONTROLLING POWER TRANSMISSION

(71) Applicant: CANON KABUSHIKI KAISHA, Tokyo (JP)

(72) Inventor: Akihiro Tanabe, Tokyo (JP)

(21) Appl. No.: 15/247,587

(22) Filed: Aug. 25, 2016

(30) Foreign Application Priority Data
Sep. 1, 2015 (JP) 2015-172275

(51) Int. Cl. H04W 52/02; H02J 7/02; H02J 50/12; H02J 50/80; H04W 52/36; H04W 4/00

(52) U.S. Cl. CPC H04W 52/0261; H04W 52/367; H04W 4/008; H02J 50/12; H02J 50/80; H02J 7/025

(57) ABSTRACT

A power transmission apparatus includes a wireless power transmission unit that wirelessly transmits power to an electronic device, a communication unit that performs data communication with the electronic device, an acquisition unit that acquires status information of the electronic device from the electronic device, and a control unit that controls, based on the acquired status information, whether data communication using the communication unit or power supply using the wireless power transmission unit is performed.

### BACKGROUND

Field

Aspects of the present invention generally relate to a power transmission apparatus that performs wireless communication, and a method for controlling power transmission.

Description of the Related Art

A wireless power transmission system is known in which power is wirelessly transmitted using an electromagnetic field resonance phenomenon or an electromagnetic induction phenomenon. Some of the power transmission apparatuses that perform wireless power transmission have a wireless communication function (see Japanese Patent Laid-Open No. 2007-325339). Japanese Patent Laid-Open No. 2007-325339 discloses a method for determining whether or not other communication devices can perform both of wireless power transmission and wireless communication.

However, even in the power transmission apparatus capable of performing both of wireless power transmission and wireless communication, it may be difficult to perform the wireless power transmission and the wireless communication in parallel depending on the state or the like of a power receiving device. In this case, the power transmission apparatus is required to be able to control whether the wireless power transmission or the wireless communication is to be performed.

### SUMMARY

According to an aspect of the present invention, a power transmission apparatus can control whether to perform wireless power transmission or wireless communication.

According to an aspect of the present invention, there is provided a power transmission apparatus including a wireless power transmission unit that wirelessly transmits power to an electronic device, a communication unit that performs data communication with the electronic device, an acquisition unit that acquires status information of the electronic device from the electronic device, and a control unit that controls, based on the acquired status information, whether data communication using the first communication unit or power supply using the wireless power transmission unit is performed.

Further features and aspects of the present invention will become apparent from the following description of exemplary embodiments.

### BRIEF DESCRIPTION OF THE DRAWINGS

FIG. 1 is a view for illustrating an example of a wireless power transmission system according to a first exemplary embodiment.

FIG. 2 is a block diagram for illustrating an example of components included in a power transmission apparatus 100 and an example of components included in an electronic device 200.

FIG. 3 is a flowchart for illustrating an example of a power transmission apparatus control process performed by the power transmission apparatus 100.

FIG. 4 is a flowchart for illustrating an example of a determination process for determining which one of a power transmission process and a wireless communication process is performed by the power transmission apparatus 100.

FIG. 5 is a flowchart for illustrating another example of the determination process for determining which one of the power transmission process and the wireless communication process is performed by the power transmission apparatus 100.

FIG. 6 is a flowchart for illustrating an example of a power receiving device control process performed by the electronic device 200.

FIG. 7 is a flowchart for illustrating an example of the wireless communication process performed by the electronic device 200.

FIG. 8 is a flowchart for illustrating an example of a power receiving process performed by the electronic device 200.

### DESCRIPTION OF THE EMBODIMENTS

Exemplary embodiments, features, and aspects of the present invention will be described below with reference to the drawings. However, aspects of the present invention are not limited to the following exemplary embodiments.

### First Exemplary Embodiment

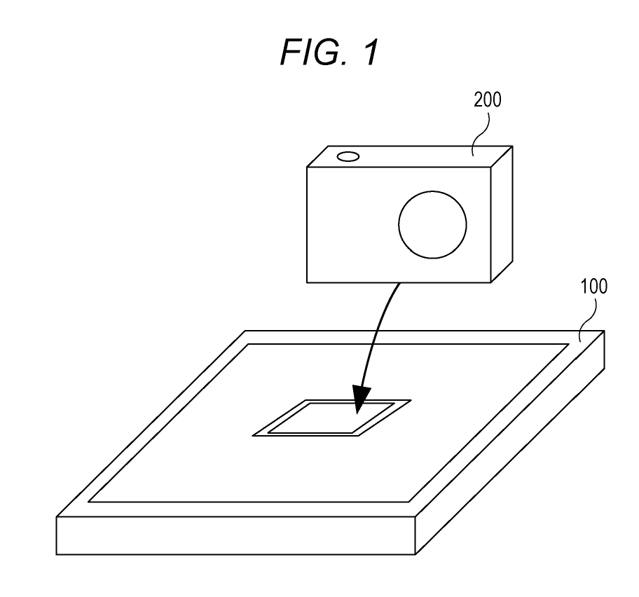

FIG. 1 is a diagram for illustrating an example of a wireless power transmission system according to a first exemplary embodiment.

As illustrated in FIG. 1, the wireless power transmission system includes a power transmission apparatus 100 and an electronic device 200. The power transmission apparatus 100 can act as a power supply device that wirelessly supplies power to the electronic device 200. The electronic device 200 is operable as a power receiving device that receives power transmitted from the power transmission apparatus 100.

In the wireless power transmission system according to the first exemplary embodiment, when the electronic device 200 is placed on the power transmission apparatus 100, the power transmission apparatus 100 wirelessly communicates with and performs power transmission to the electronic device 200 via an antenna. When a distance between the power transmission apparatus 100 and the electronic device 200 falls within a predetermined range, the electronic device 200 including an antenna wirelessly receives power output from the power transmission apparatus 100 via the antenna. Further, the electronic device 200 can charge a battery connected to the electronic device 200 with power received from the power transmission apparatus 100 via the antenna.

When the distance between the power transmission apparatus 100 and the electronic device 200 does not fall within the predetermined range, the electronic device 200 cannot communicate with the power transmission apparatus 100 even if the electronic device 200 includes an antenna. The predetermined range is a range in which the electronic device 200 can perform communication using power supplied from the power transmission apparatus 100.

Assume that the power transmission apparatus 100 can wirelessly supply power to electronic devices in parallel.

The electronic device 200 can be an image capture device such as a smartphone, a digital camera, a camera-equipped portable telephone, or a digital video camera. The electronic device 200 can be a reproduction device that reproduces audio data or image data. The electronic device 200 can be a mobile device such as a vehicle. When the electronic device 200 is not connected with the battery, the electronic device 200 can be an electronic device that operates using power supplied from the power transmission apparatus 100.

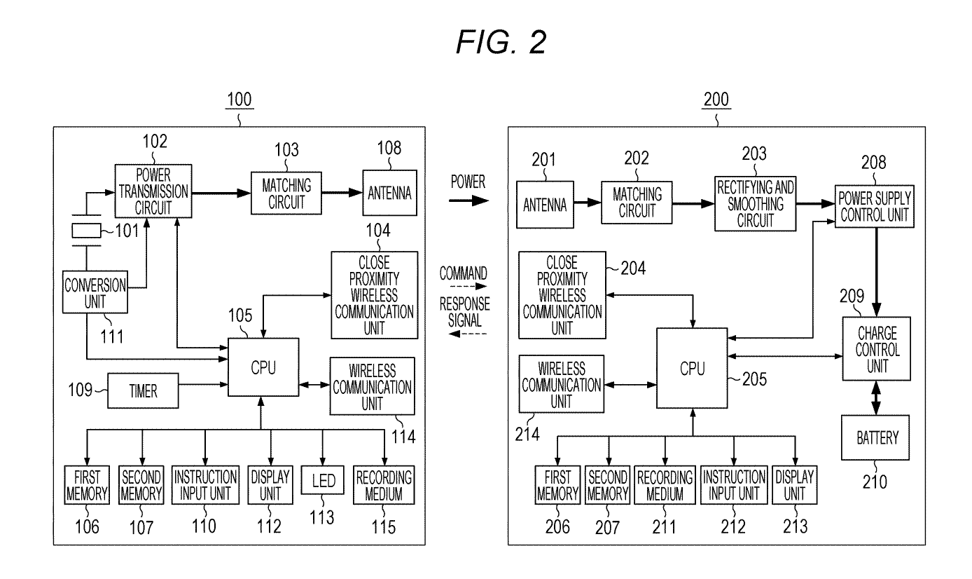

FIG. 2 is a block diagram for illustrating an example of components included in the power transmission apparatus 100 and an example of components included in the electronic device 200.

As illustrated in FIG. 2, the power transmission apparatus 100 includes an oscillator 101, a power transmission circuit 102, a matching circuit 103, a close proximity wireless communication unit 104, a CPU (central processing unit) 105, a first memory 106, and a second memory 107. The power transmission apparatus 100 further includes an antenna 108, a timer 109, an instruction input unit 110, a conversion unit 111, a display unit 112, an LED 113, a wireless communication unit 114, and a recording medium 115. The recording medium 115 can be detachable from the power transmission apparatus 100.

The oscillator 101 is driven by power supplied from an AC power supply via the conversion unit 111, and oscillates a frequency used for controlling the power transmission circuit 102. A crystal vibration device or the like is used as the oscillator 101.

The power transmission circuit 102 generates power to be supplied to the electronic device 200 via the antenna 108 according to power supplied from the conversion unit 111 and the frequency oscillated by the oscillator 101. The power transmission circuit 102 includes an FET and the like formed therein, and controls a current flowing between source and drain terminals by a gate voltage of the internal FET according to the frequency oscillated by the oscillator 101, thereby generating power to be supplied to the electronic device 200. Power generated by the power transmission circuit 102 is supplied to the matching circuit 103. The power transmission circuit 102 controls the gate voltage of the internal FET, thereby making it possible to change or stop the power from the FET.

The matching circuit 103 is a resonance circuit that resonates at a resonance frequency f as represented by the following formula (1) by the antenna 108 and the capacitance of the capacitor according to the frequency oscillated by the oscillator 101.

The frequency at which the power transmission apparatus 100 and the power transmission target device of the power transmission apparatus 100 resonate is hereinafter referred to as the “resonance frequency f”.

The following formula (1) represents the resonance frequency f. L represents the inductance of the antenna 108 and C represents the capacitance of the matching circuit 103.

f=1/{2π(LC)^{1/2}} (1)

Note that the resonance frequency f can be, for example, 50/60 Hz, which is a commercial frequency, 10 to several hundred kHz, or a frequency of about 10 MHz.

In a state where the frequency oscillated by the oscillator 101 is set to the resonance frequency f, power generated by the power transmission circuit 102 is supplied to the antenna 108 via the matching circuit 103.

The close proximity wireless communication unit 104 is a hardware block composed of a communication processing circuit for performing close proximity wireless communication and an antenna. For example, a communication process based on the NFC (Near Field Communication) standard, Bluetooth® standard, or the like is performed. In the case of communication based on the NFC standard, a loop antenna is used as the antenna, and in the case of communication based on Bluetooth® standard, a dipole antenna is used as the antenna. In the case of communication based on the NFC standard, the antenna 108 for power transmission can be used for communication.

When the AC power supply and the power transmission apparatus 100 are connected to each other, the CPU 105 controls the components of the power transmission apparatus 100 by power supplied from the AC power supply via the conversion unit 111. The CPU 105 executes one or more programs stored in the first memory 106, thereby controlling the components of the power transmission apparatus 100. The CPU 105 controls the power transmission circuit 102, thereby controlling the power to be supplied to the electronic device 200. The CPU 105 controls the close proximity wireless communication unit 104 and the wireless communication unit 114, thereby performing communication with the electronic device 200. The CPU 105 controls the close proximity wireless communication unit 104 to request the electronic device 200 for device authentication, acquisition of charge information, or the like. The CPU 105 controls the close proximity wireless communication unit 104, thereby establishing a connection by the wireless communication unit 114. Further, the CPU 105 controls the wireless communication unit 114, thereby making it possible to transmit image data or audio data, which are stored in the recording medium 115, to the electronic device 200, and to receive the image data or audio data from the electronic device 200.

The CPU 105 acquires, from the electronic device 200, device information including information about the electronic device 200 and status information indicating the state or the like of the electronic device 200 via the close proximity wireless communication unit 104 or the wireless communication unit 114. The device information includes the manufacturer name, product name, product model number, product ID, serial number, and the like of the electronic device 200. The device information includes information indicating whether the wireless communication unit 214 can perform data communication using power wirelessly transmitted from the electronic device 200. The status information includes charge information which is information about the charge state of the battery 210 connected to the electronic device 200. The status information includes information indicating whether the data stored in the recording medium 211 is updated, information indicating whether the close proximity wireless communication unit 204 is valid, and information indicating whether the wireless communication unit 214 is valid. The status information includes information indicating the presence or absence of the recording medium 211, information indicating the open or closed state of a lid for storing the recording medium 211, information indicating the presence or absence of the battery 210, and information indicating the open or closed state of a lid of a storage unit for storing the battery 210.

The first memory 106 is a memory for storing one or more programs for controlling the components of the power transmission apparatus 100 and information about the operation and state of the components of the power transmission apparatus 100. The first memory 106 also stores image data, such as menu information, to be displayed on the display unit 112.

The second memory 107 is a rewritable memory. The second memory 107 can act as a working memory for the CPU 105. Accordingly, the second memory 107 can store various pieces of information, data, values, parameters, and programs used for the CPU 105. The CPU 105 can store, in the second memory 107, various pieces of information, data, values, and parameters received from the electronic device 200.

The antenna 108 is an antenna for outputting power generated by the power transmission circuit 102 to the outside. The power transmission apparatus 100 supplies power to the electronic device 200 via the antenna 108.

The timer 109 measures a present time and a time for an operation or process performed by each of the components. A threshold for the time measured by the timer 109 is preliminarily recorded in the first memory 106.

The instruction input unit 110 provides a user interface for inputting a user's instruction to the power transmission apparatus 100. The instruction input unit 110 includes a power supply button for turning on or off the power supply of the power transmission apparatus 100, a mode switch button for switching the operation mode of the power transmission apparatus 100, and the like. Each button is composed of a switch, a touch panel, and the like. The CPU 105 controls the power transmission apparatus 100 in accordance with the user's instruction input through the instruction input unit 110. The instruction input unit 110 can control the power transmission apparatus 100 in accordance with an instruction received from a remote controller.

When the AC power supply and the power transmission apparatus 100 are connected to each other, the conversion unit 111 converts an AC power supplied from the AC power supply into a DC power, and supplies the converted DC power to the components of the power transmission apparatus 100.

The display unit 112 is a display unit that displays the content of the display generated by the CPU 105. For example, the display unit 112 is composed of a liquid crystal panel, an organic EL panel, or the like, and a display control unit that controls these components.

The LED 113 is composed of a light emitting diode and controlled by the CPU 105, thereby emitting light to notify a user that the close proximity wireless communication unit 104 is controlled to perform communication, or that the power transmission circuit 102 is controlled to output power.

The wireless communication unit 114 is composed of a communication processing circuit for performing wireless communication, and an antenna. The wireless communication unit 114 is a process block for performing a communication process based on, for example, a wireless LAN (Local Area Network) standard or an LTE (Long Term Evolution) standard. The wireless communication unit 114 can employ the same communication method as that of the close proximity wireless communication unit 104.

The recording medium 115 can store image data or audio data. A flash memory or a hard disk device is an example of the recording medium 115. The recording medium 115 can be detachable from the electronic device 200.

Referring to FIG. 2, the electronic device 200 includes an antenna 201, a matching circuit 202, a rectifying and smoothing circuit 203, a close proximity wireless communication unit 204, a CPU (central processing unit) 205, a first memory 206, and a second memory 207. The electronic device 200 further includes a power supply control unit 208, a charge control unit 209, an instruction input unit 212, a display unit 213, and a wireless communication unit 214. The battery 210 can be detachable from the electronic device 200. The recording medium 211 can also be detachable from the electronic device 200.

The antenna 201 is an antenna for receiving power supplied from the power transmission apparatus 100. The electronic device 200 receives power from the power transmission apparatus 100 via the antenna 201, thereby receiving a request. The electronic device 200 can transmit a request for controlling the power transmission apparatus 100 via the antenna 201, and can also transmit a response and predetermined information corresponding to the request received from the power transmission apparatus 100.

The matching circuit 202 is a resonance circuit for performing impedance matching so that the antenna 201 resonates at the same frequency as the resonance frequency f of the power transmission apparatus 100. Like the matching circuit 103, the matching circuit 202 includes a condenser, a coil, a resistance, and the like. The matching circuit 202 is configured such that the antenna 201 resonates at the same frequency as the resonance frequency f of the power transmission apparatus 100. The matching circuit 202 supplies power received by the antenna 201 to the rectifying and smoothing circuit 203. The matching circuit 202 supplies the close proximity wireless communication unit 204 with a part of power received by the antenna 201 in the form of an AC waveform as a request.

The rectifying and smoothing circuit 203 eliminates the request and noise from power received by the antenna 201, thereby generating the DC power. Further, the rectifying and smoothing circuit 203 supplies the generated DC power to the power supply control unit 208. The rectifying and smoothing circuit 203 includes a diode for rectification, and generates the DC power by one of full-wave rectification and half-wave rectification. The DC power generated by the rectifying and smoothing circuit 203 is supplied to the power supply control unit 208.

The close proximity wireless communication unit 204 is a hardware block composed of a communication processing circuit for performing close proximity wireless communication, and an antenna. For example, the close proximity wireless communication unit 204 performs a communication process based on an NFC (Near Field Communication) standard or a Bluetooth® standard. In the case of communication based on the NFC standard, the antenna is configured as a loop antenna. In the case of communication based on the Bluetooth® standard, the antenna is configured as a dipole antenna. In the case of communication based on the NFC standard, the antenna 201 for power receiving can be used for communication. In the case of communication based on the NFC standard, the close proximity wireless communication unit 204 can include a non-volatile memory for storing data.

The CPU 205 controls the components of the electronic device 200 by executing one or more programs stored in the first memory 206. The CPU 205 controls the power supply control unit 208 and the charge control unit 209, thereby supplying power supplied from the power transmission apparatus 100 to the components of the electronic device 200, and charging the battery 210. The CPU 205 controls the close proximity wireless communication unit 204 and the wireless communication unit 214 and performs a wireless communication process. The CPU 205 can transmit a response to a device authentication request from the power transmission apparatus 100 via the close proximity wireless communication unit 204, and can transmit a response to a request for acquiring charge information via the close proximity wireless communication unit 204. The CPU 205 controls the close proximity wireless communication unit 204 to establish a connection for the wireless communication unit 214 to perform wireless communication. Further, the CPU 205 controls the wireless communication unit 214, thereby transmitting image data or audio data, which are stored in the recording medium 211, to the power transmission apparatus 100, and receiving the image data or audio data from the power transmission apparatus 100.

The first memory 206 is a memory for storing one or more programs for controlling the components of the electronic device 200 and information about the operation and state of the components of the electronic device 200. The first memory 206 also stores device information including information about the electronic device 200.

The second memory 207 is a rewritable memory. The second memory 207 can act as a working memory for the CPU 205. Accordingly, the second memory 207 can store various pieces of information, data, values, parameters, and programs used for the CPU 205. The CPU 205 can store, in the second memory 207, various pieces of information, data, values, and parameters received from the power transmission apparatus 100.

The power supply control unit 208 is composed of a switching regulator, a linear regulator, or the like, and supplies the DC power supplied from one of the rectifying and smoothing circuit 203 and an external power supply to charge control unit 209 and the components of the electronic device 200.

When power is supplied from the power supply control unit 208, the charge control unit 209 charges the battery 210 with power supplied from the power supply control unit 208. The charge control unit 209 periodically detects a charge state of the battery 210 connected to the electronic device 200, and supplies the CPU 205 with charge information which is information about the charge state of the battery 210. The CPU 205 records the charge information, which is information about the charge state of the battery 210, in the second memory 207 as a part of the status information.

The charge information includes not only remaining amount information indicating the remaining amount of the battery 210, but also information indicating whether the battery 210 is in a fully charged state. The charge information can include information indicating an elapsed time after starting charging of the battery 210. The charge information includes information indicating that the charge control unit 209 performs a constant voltage charge or a constant current charge. The charge information includes information indicating that the charge control unit 209 performs a trickle charge or a rapid charge. The charge information includes power information necessary for the electronic device 200 to charge the battery 210, and information indicating a temperature state of the battery 210. The charge information includes information indicating a remaining amount of the battery 210 necessary for causing the electronic device 200 to operate. The charge information includes information indicating how much a remaining amount of the battery 210 is reduced when the power supply from the power transmission apparatus 100 is stopped. The charge information includes information indicating the number of times of charging the battery 210, the degree of consumption, or the degree of degradation.

The battery 210 is a chargeable secondary battery and is detachable from the electronic device 200. Examples of the battery 210 include a lithium ion battery. The battery 210 can supply power to the components of the electronic device 200. When the battery 210 is not supplied with power via the power supply control unit 208, the battery 210 supplies power to the components of the electronic device 200. For example, when a first power is set to a low level and output from the power transmission apparatus 100 during communication, power is supplied to the components of the electronic device 200 from the battery 210. For example, when the power supply from the power transmission apparatus 100 is stopped, power is supplied to the components of the electronic device 200 from the battery 210. A signal indicating an open or closed state of a lid of a storage unit for storing the battery 210 is sent to the CPU 205. When the open or closed state of the lid of the storage unit for storing the battery 210 is changed, or when the connection of the battery 210 is changed, the CPU 205 updates the status information of the electronic device 200 recorded in the second memory 207.

The recording medium 211 is detachable from the electronic device 200 and can store image data or audio data. A flash memory or a hard disk device is an example of the recording medium 115. The signal indicating the open or closed state of the lid of the storage unit for storing the recording medium 211 is sent to the CPU 205. When the open or closed state of the lid of the storage unit for storing the recording medium 211 is changed, or when the connection of the recording medium 211 is changed, the CPU 205 updates the status information of the electronic device 200 recorded in the second memory 207. When the CPU 205 updates the data stored in the recording medium 211, information indicating whether the data is updated, which is one piece of status information, is changed to “updated”. When the CPU 205 transfers the data stored in the recording medium 211 to the power transmission apparatus 100, the CPU 205 changes the information indicating whether the data is updated, which is one piece of status information, to “not updated”.

The instruction input unit 212 provides a user interface for inputting the user's instruction to the electronic device 200. The instruction input unit 212 includes a power supply button for turning on or off the power supply of the electronic device 200, a mode switch button for switching the operation mode of the electronic device 200, and the like. Each button is composed of a switch, a touch panel, and the like. The CPU 205 controls electronic device 200 in accordance with the user's instruction input through the instruction input unit 212. The instruction input unit 212 can control the electronic device 200 in accordance with an instruction received from a remote controller. The user inputs an instruction to the instruction input unit 212 while viewing the menu displayed on the display unit 213, thereby making it possible to select whether to validate the close proximity wireless communication unit 204 or not. Similarly, the user inputs an instruction to the instruction input unit 212 while viewing the menu displayed on the display unit 213, thereby making it possible to select whether to validate the wireless communication unit 214 or not. When whether the wireless communication unit 214 is valid or invalid is selected, the CPU 205 updates the status information to update the information indicating whether the wireless communication unit 214 is valid or invalid.

The display unit 213 is composed of a liquid crystal panel, an organic EL panel, or the like, and displays an operation screen, a captured image, and the like based on an instruction from the CPU 205. The display unit 213 can be configured to be movable, such as a variable-angle display. In this case, position information of the display unit 213 is converted into digital information and the digital information is sent to the CPU 205.

The wireless communication unit 214 is composed of a communication processing circuit for performing wireless communication, and an antenna. The wireless communication unit 214 is a process block for performing a communication process based on, for example, a wireless LAN (Local Area Network) standard or an LTE (Long Term Evolution) standard. The wireless communication unit 214 can employ the same communication method as that of the close proximity wireless communication unit 204.

The antenna 108 and the antenna 201 can be helical antennas, loop antennas, or planar antennas, such as meander line antennas.

In the first exemplary embodiment, the power transmission apparatus 100 includes the close proximity wireless communication unit 104 and the wireless communication unit 114, but instead can include either the close proximity wireless communication unit 104 or the wireless communication unit 114. The electronic device 200 includes the close proximity wireless communication unit 104 and the wireless communication unit 114, but instead can include either the close proximity wireless communication unit 104 or the wireless communication unit 114. Accordingly, all the processes performed by the close proximity wireless communication unit 104 can be performed by the wireless communication unit 114, and all the processes performed by the wireless communication unit 114 can be performed by the close proximity wireless communication unit 104. Similarly, all the processes performed by the close proximity wireless communication unit 204 can be performed by the wireless communication unit 214, and all the processes performed by the wireless communication unit 214 can be performed by the close proximity wireless communication unit 204.

In the first exemplary embodiment, the process performed by the power transmission apparatus 100 can also be applied to a system in which the power transmission apparatus 100 wirelessly supplies power to the electronic device 200 by magnetic field coupling or capacitive coupling. Similarly, in the first exemplary embodiment, the process performed by the electronic device 200 can also be applied to a system in which the power transmission apparatus 100 wirelessly supplies power to the electronic device 200 by magnetic field coupling or electric field coupling.

The wireless power transmission system according to the first exemplary embodiment can be configured in such a manner that an electrode is provided on the power transmission apparatus 100 as the antenna 108 and an electrode is provided on the electronic device 200 as the antenna 201, thereby allowing the power transmission apparatus 100 to supply power to the electronic device 200 by capacitive coupling.

The wireless power transmission system according to the first exemplary embodiment can be configured in such a manner that the power transmission apparatus 100 wirelessly supplies power to the electronic device 200 by electromagnetic induction.

In the first exemplary embodiment, the power transmission apparatus 100 wirelessly transmits power to the electronic device 200 and the electronic device 200 wirelessly receives power from the power transmission apparatus 100. However, the term “wirelessly” can also be expressed as “in a non-touch manner” or “in a non-contact manner”.

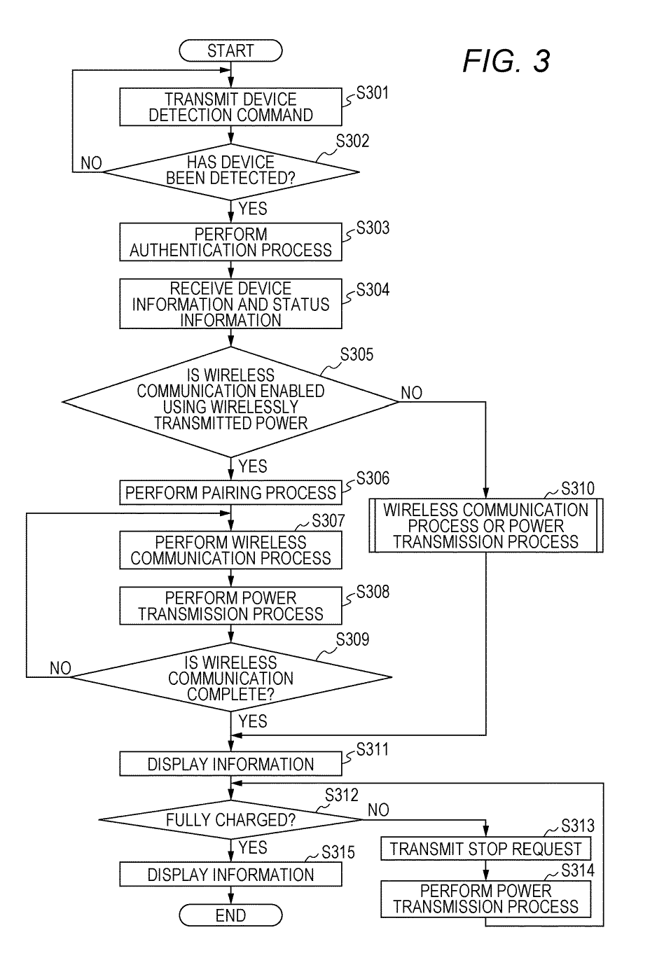

FIG. 3 is a flowchart for illustrating an example of a power transmission apparatus control process performed by the power transmission apparatus 100. This power transmission apparatus control process is controlled such that the CPU 105 executes a program stored in the first memory 106.

In S301, the CPU 105 transmits a command for device detection from the close proximity wireless communication unit 104 to the electronic device 200. After that, the CPU 105 proceeds from S301 to S302.

In S302, the CPU 105 determines whether the electronic device 200 is present in the neighborhood or not. For example, the CPU 105 determines whether the electronic device 200 is present or not, based on a response signal received from the electronic device 200 via the close proximity wireless communication unit 104. When the electronic device 200 is present (YES in S302), the CPU 105 proceeds from S302 to S303. When the electronic device 200 is not present (NO in S302), the CPU 105 returns from S302 to S301.

In S303, the CPU 105 transmits a predetermined command in connection with an authentication process to the electronic device 200 from the close proximity wireless communication unit 104, and receives a response signal from the electronic device 200 via the close proximity wireless communication unit 104, thereby performing the authentication process. The CPU 105 completes the authentication process and proceeds from S303 to S304.

In S304, the CPU 105 transmits a request for acquiring the device information and status information of the electronic device 200 to the electronic device 200 from the close proximity wireless communication unit 104. Further, the CPU 105 acquires the device information and status information of the electronic device 200 from the electronic device 200 via the close proximity wireless communication unit 104. Then, the CPU 105 stores the acquired device information and status information of the electronic device 200 in the second memory 107, and proceeds from S304 to S305. In S304, the CPU 105 can transmit the device information and status information of the power transmission apparatus 100 to the electronic device 200.

In S305, the CPU 105 determines, by referring to the acquired device information, whether the electronic device 200 can perform data communication by the wireless communication unit 214 using the wirelessly transmitted power or not. When the electronic device 200 can perform data communication by the wireless communication unit 214 using the wirelessly transmitted power (YES in S305), the CPU 105 proceeds from S305 to S306. When the electronic device 200 cannot perform data communication by the wireless communication unit 214 using the wirelessly transmitted power (NO in S305), the CPU 105 proceeds from S305 to S310.

In S306, the CPU 105 performs a pairing process for establishing a connection by a wireless LAN, Wi-Fi Direct®, etc. The CPU 105 controls the close proximity wireless communication unit 104 to transmit, to the electronic device 200, a request for acquiring connection information, such as the IP address, SSID, password, channel information, and the like, which are necessary for the wireless communication unit 114 to communicate with the wireless communication unit 214 of the electronic device 200. Further, the connection information, such as the IP address, SSID, password, channel information, or the like, is acquired from the electronic device 200 via the close proximity wireless communication unit 104. Similarly, the CPU 105 controls the close proximity wireless communication unit 104 and transmits, to the electronic device 200, connection information, such as an IP address, an SSID, a password, and a channel, which are necessary for the wireless communication unit 214. The CPU 105 proceeds from S306 to S307.

In S307, the CPU 105 uses the connection information acquired in S306 to establish a connection with the electronic device 200 via the wireless communication unit 114, thereby performing communication. At this time, the CPU 105 controls the wireless communication unit 114 to acquire non-acquired data from the data recorded in the recording medium 211 of the electronic device 200, and records the acquired data in the recording medium 115. Alternatively, the CPU 105 can transmit the data recorded in the recording medium 115 to the electronic device 200. After that, the CPU 105 proceeds from S307 to S308.

In S308, the CPU 105 controls the power transmission circuit 102 using the acquired status information, power necessary for the electronic device 200 is supplied to the electronic device 200. The CPU 105 periodically acquires the charge information from the electronic device 200 via the close proximity wireless communication unit 104, and controls the power transmission circuit 102 using the acquired electronic device 200. The CPU 105 can periodically acquire the charge information from the electronic device 200 via the close proximity wireless communication unit 104. In this case, power supply is performed in parallel with data communication by the wireless communication unit 114. After that, the CPU 105 proceeds from S308 to S309.

In S309, the CPU 105 determines whether the wireless communication process is complete or not. When the wireless communication process is complete (YES in S309), the CPU 105 proceeds from S309 to S311. When the wireless communication process is not complete (NO in S309), the CPU 105 returns from S309 to S307.

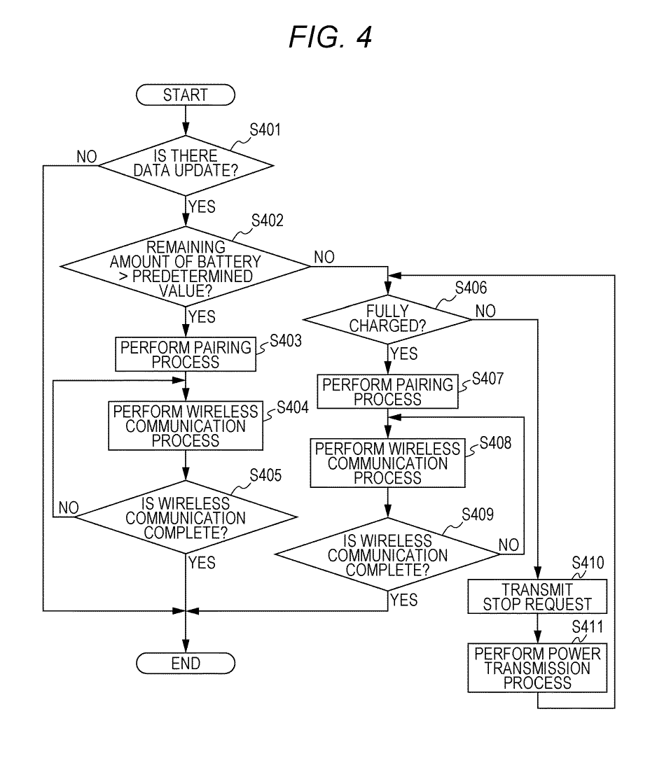

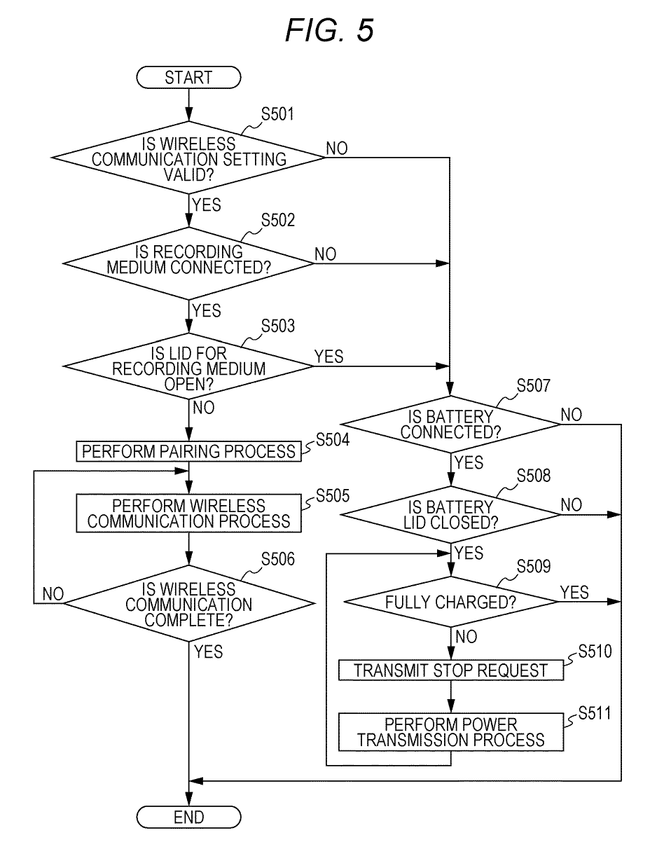

In S310, the CPU 105 performs a determination process for determining which one of a power transmission process and a wireless communication process is performed. Details of the determination process performed in S310 will be described later with reference to FIGS. 4 and 5. After the determination process performed in S310 is terminated, the CPU 105 proceeds from S310 to S311.

In S311, the CPU 105 displays, on the display unit 112, information indicating that the wireless communication process is complete. In S311, the CPU 105 controls the LED 113 to notify the user that the wireless communication process is complete. The CPU 105 proceeds from S311 to S312.

In S312, the CPU 105 determines whether the battery 210 is in the fully charged state or not, by referring to the charge information acquired from the electronic device 200. When the battery 210 is in the fully charged state (YES in S312), the CPU 105 proceeds from S312 to S315. When the battery 210 is not in the fully charged state (NO in S312), the CPU 105 proceeds from S312 to S313.

In S313, the CPU 105 controls the close proximity wireless communication unit 104 or the wireless communication unit 114 to transmit, to the electronic device 200, a request for stopping components other than hardware processing units associated with charging of the battery 210. The CPU 105 proceeds from S313 to S314.

In S314, the CPU 105 performs a process similar to the process performed in S308 for a predetermined time, and returns to S312.

In S315, the CPU 105 displays, on the display unit 112, information indicating that charging is complete. In S315, the CPU 105 controls the LED 113 to notify the user that charging is complete. After that, the CPU 105 terminates the power transmission apparatus control process.

FIG. 4 is a flowchart for illustrating a first determination process as an example of the determination process performed in S310. The first determination process is a process for determining which of the power transmission process and the wireless communication process is performed by the power transmission apparatus 100. The first determination process is controlled such that the CPU 105 executes a program stored in the first memory 106.

In S401, the CPU 105 determines whether the data recorded in the recording medium 211 is updated or not, by referring to the status information of the electronic device 200 acquired in S304. When the data recorded in the recording medium 211 is updated (YES in S401), the CPU 105 proceeds from S401 to S402. When the data recorded in the recording medium 211 is not updated (NO in S401), the CPU 105 terminates the first determination process. Whether the data recorded in the recording medium 211 is updated or not can be determined in such a manner that the data recorded in the recording medium 211 is compared with the data recorded in the recording medium 115, and when there is data that is not recorded in the recording medium 115, it is determined that the data recorded in the recording medium 211 is updated.

In S402, the CPU 105 determines whether the remaining amount of the battery 210 is greater than a predetermined value or not, by referring to the charge information included in the status information of the electronic device 200. When the remaining amount of the battery 210 is greater than the predetermined value (YES in S402), the CPU 105 proceeds from S402 to S403. When the remaining amount of the battery 210 is not greater than the predetermined value (NO in S402), the CPU 105 proceeds from S402 to S406.

In S403, the CPU 105 performs a process similar to the process performed in S306 and proceeds from S403 to S404.

In S404, the CPU 105 performs a process similar to the process performed in S307 and proceeds from S404 to S405.

In S405, the CPU 105 performs a process similar to the process performed in S309. When the wireless communication process is complete (YES in S405), the CPU 105 terminates the first determination process. When the wireless communication process is not complete (NO in S405), the CPU 105 returns from S405 to S404.

In S406, the CPU 105 performs a process similar to the process performed in S312. When the battery 210 is in the fully charged state (YES in S406), the CPU 105 proceeds from S406 to S407. When the battery 210 is not in the fully charged state (NO in S406), the CPU 105 proceeds from S406 to S410.

In S407, the CPU 105 performs a process similar to the process performed in S306. After that, the CPU 105 proceeds from S407 to S408.

In S408, the CPU 105 performs a process similar to the process performed in S307 and proceeds from S408 to S409.

In S409, the CPU 105 performs a process similar to the process performed in S309. When the wireless communication process is complete (YES in S409), the CPU 105 terminates the first determination process. When the wireless communication process is not complete (NO in S409), the CPU 105 returns from S409 to S408.

In S410, the CPU 105 performs a process similar to the process performed in S313 and proceeds from S410 to S411.

In S411, the CPU 105 performs a process similar to the process performed in S314 and proceeds from S411 to S406.

FIG. 5 is a flowchart for illustrating a second determination process as another example of the determination process performed in S310. The second determination process is a process for determining which one of the power transmission process and the wireless communication process is performed by the power transmission apparatus 100. The second determination process is controlled such that the CPU 105 executes a program stored in the first memory 106.

In S501, the CPU 105 determines whether the wireless communication unit 214 is valid or not, by referring to the status information of the electronic device 200. When the wireless communication unit 214 is valid (YES in S501), the CPU 105 proceeds from S501 to S502. When the wireless communication unit 214 is not valid (NO in S501), the CPU 105 proceeds from S501 to S507. The CPU 105 can determine whether the close proximity wireless communication unit 204 is valid or not, instead of determining whether the wireless communication unit 214 is valid or not.

In S502, the CPU 105 determines whether the recording medium 211 is present or not by referring to the status information of the electronic device 200. When the recording medium 211 is present in the electronic device 200 (YES in S502), the CPU 105 proceeds from S502 to S503. When the recording medium 211 is not present in the electronic device 200 (NO in S502), the CPU 105 proceeds from S502 to S507.

In S503, the CPU 105 determines whether the lid is open or not, by referring to the status information of the electronic device 200. When the lid of the storage unit for storing the recording medium 211 is not open (NO in S503), the CPU 105 proceeds from S503 to S504. When the lid of the storage unit for storing the recording medium 211 is open (YES in S503), the CPU 105 proceeds from S503 to S507.

In S504, the CPU 105 performs a process similar to the process performed in S306 and proceeds from S504 to S505.

In S505, the CPU 105 performs a process similar to the process performed in S307 and proceeds from S505 to S506.

In S506, the CPU 105 performs a process similar to the process performed in S309. When the wireless communication process is complete (YES in S506), the CPU 105 terminates the second determination process. When the wireless communication process is not complete (NO in S506), the CPU 105 returns from S506 to S505.

In S507, the CPU 105 determines whether the battery 210 is present or not by referring to the status information of the electronic device 200. When the battery 210 is connected (YES in S507), the CPU 105 proceeds from S507 to S508. When the battery 210 is not connected (NO in S507), the CPU 105 terminates the second determination process.

In S508, the CPU 105 determines whether the lid of the storage unit for storing the battery 210 is closed or not, by referring to the status information of the electronic device 200. When the lid of the storage unit for storing the battery 210 is closed (YES in S508), the CPU 105 proceeds from S508 to S509. When the lid of the storage unit for storing the battery 210 is not closed (NO in S508), the CPU 105 terminates the second determination process.

In S509, the CPU 105 performs a process similar to the process performed in S312. When the battery 210 is in the fully charged state (YES in S509), the CPU 105 terminates the second determination process. When the battery 210 is not in the fully charged state (NO in S509), the CPU 105 proceeds from S509 to S510.

In S510, the CPU 105 performs a process similar to the process performed in S313 and proceeds from S510 to S511.

In S511, the CPU 105 performs a process similar to the process performed in S314 and returns from S511 to S509.

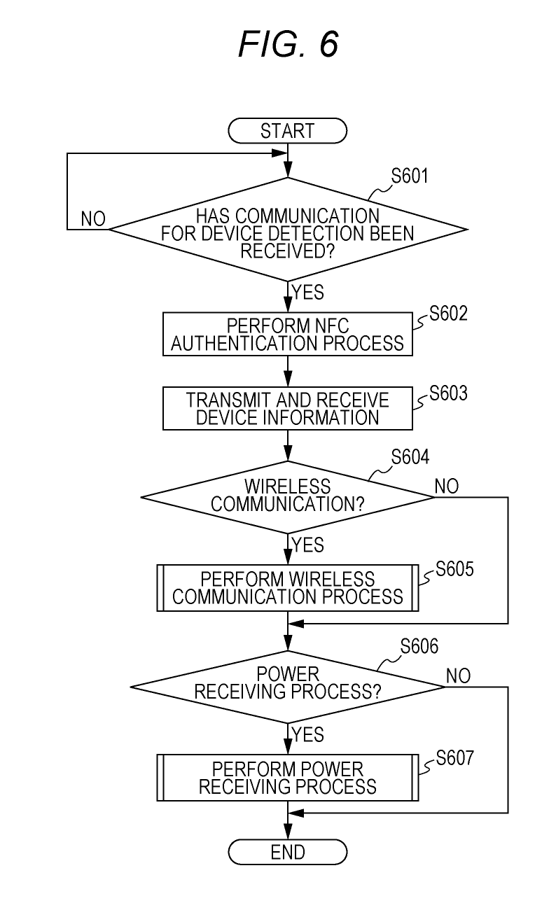

FIG. 6 is a flowchart for illustrating an example of the power receiving device control process performed in the electronic device 200. This power receiving device control process is controlled such that the CPU 205 executes a program stored in the first memory 206.

In S601, the CPU 205 determines whether the close proximity wireless communication unit 204 receives a command for device detection from the power transmission apparatus 100 or not. When it is determined that the command for device detection is received (YES in S601), the CPU 205 proceeds from S601 to S602. When the command for device detection is not received (NO in S601), the CPU 205 repeats the process in S601.

In S602, the CPU 205 causes the close proximity wireless communication unit 204 to transmit a response signal for the command for device detection to the power transmission apparatus 100. Further, the CPU 205 performs the authentication process together with the power transmission apparatus 100. For example, the CPU 205 receives a predetermined command in connection with the authentication process from the power transmission apparatus 100 via the close proximity wireless communication unit 204 and controls the close proximity wireless communication unit 204 to transmit a response signal to the power transmission apparatus 100. The CPU 205 performs the authentication process and then proceeds from S602 to S603.

In S603, the CPU 205 receives a request for acquiring the device information and status information of the electronic device 200 from the power transmission apparatus 100 via the close proximity wireless communication unit 204. In response to the acquisition request, the device information or status information stored in the second memory 207 or the memory within the close proximity wireless communication unit 204 is sent back as a response. The device information and status information of the power transmission apparatus 100 can be received from the power transmission apparatus 100. In this case, the CPU 205 stores the received device information and status information of the power transmission apparatus 100 in the second memory 207. The CPU 205 transmits the device information and status information to the power transmission apparatus 100, and then proceeds from S603 to S604.

In S604, the CPU 205 determines whether to perform the wireless communication process between the power transmission apparatus 100 and the electronic device 200 or not. The CPU 205 performs the determination based on the device information and status information of the electronic device 200. When it is determined that the wireless communication process between the power transmission apparatus 100 and the electronic device 200 is performed (YES in S604), the CPU 205 proceeds from S604 to S605. When it is determined that the wireless communication process between the power transmission apparatus 100 and the electronic device 200 is not performed (NO in S604), the CPU 205 proceeds from S604 to S606.

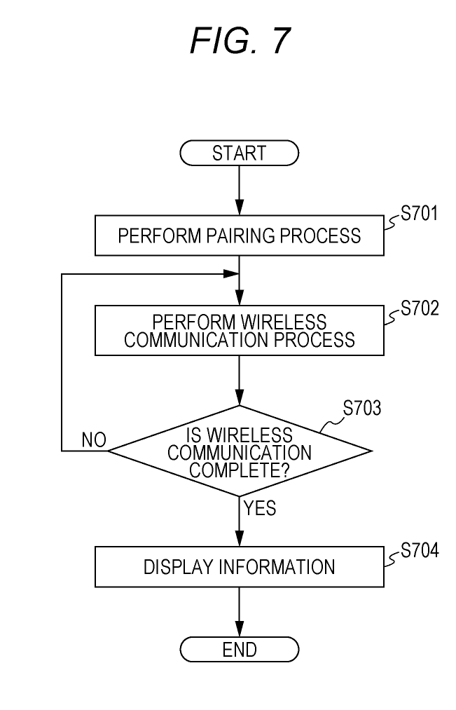

In S605, the CPU 205 generates a thread for performing the wireless communication process between the power transmission apparatus 100 and the electronic device 200, and starts the wireless communication process. The wireless communication process performed in S605 will be described later with reference to FIG. 7. After the wireless communication process is terminated, the CPU 205 proceeds from S605 to S606.

In S606, the CPU 205 determines whether to perform the power transmission process between the power transmission apparatus 100 and the electronic device 200 or not. The CPU 205 performs the determination based on the device information and status information of the electronic device 200. When it is determined that the power transmission process between the power transmission apparatus 100 and the electronic device 200 is performed (YES in S606), the CPU 205 proceeds from S606 to S607. When it is determined that the power transmission process between the power transmission apparatus 100 and the electronic device 200 is not performed (NO in S606), the CPU 205 terminates the power receiving device control process.

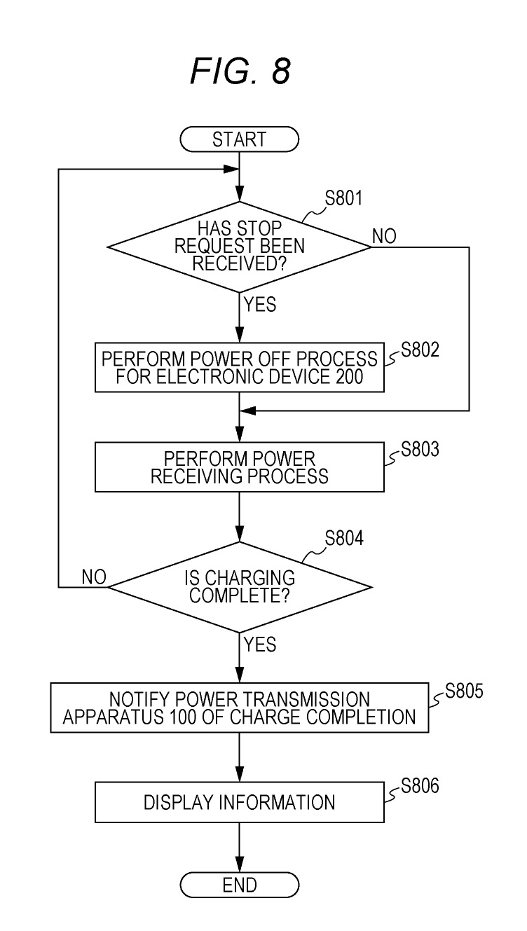

In S607, the CPU 205 generates a thread for performing the power transmission process between the power transmission apparatus 100 and the electronic device 200, and starts the power receiving process. The power receiving process performed in S607 will be described later with reference to FIG. 8. After the power receiving process is terminated, the CPU 205 terminates the power receiving device control process.

FIG. 7 is a flowchart for illustrating an example of the wireless communication process performed in S605. This wireless communication process is controlled such that the CPU 205 executes a program stored in the first memory 206.

In S701, the CPU 205 performs a pairing process for establishing a connection by a wireless LAN or the like. The CPU 205 controls the close proximity wireless communication unit 204 according to a request for acquiring connection information, from the power transmission apparatus 100, and transmits the connection information, such as the IP address, SSID, password, and channel, which are necessary for the wireless communication unit 114. The CPU 205 controls the close proximity wireless communication unit 204 to acquire the connection information, such as the IP address, SSID, password, and channel information, which are necessary for the wireless communication unit 214 so as to communicate with the wireless communication unit 114 of the power transmission apparatus 100. The CPU 205 proceeds from S701 to S702.

In S702, the CPU 205 uses the connection information acquired in S701 to establish a connection with the power transmission apparatus 100 via the wireless communication unit 214, thereby performing communication. At this time, the CPU 205 transmits non-transferred data in the data recorded in the recording medium 211 from the wireless communication unit 214 to the power transmission apparatus 100. The CPU 205 can receive data recorded in the recording medium 115 of the power transmission apparatus 100, and can record the received data in the recording medium 211. After that, the CPU 205 proceeds from S702 to S703.

In S703, the CPU 205 controls the wireless communication unit 214 and determines whether the wireless communication process is complete or not. When the wireless communication process is complete (YES in S703), the CPU 205 proceeds from S703 to S704. When the wireless communication process is not complete (NO in S703), the CPU 105 returns from S703 to S702.

In S704, the CPU 205 displays, on the display unit 213, information indicating that the wireless communication process is complete. In S704, the CPU 205 controls the LED and notifies the user that the wireless communication process is complete. Then, the CPU 205 terminates the wireless communication process.

FIG. 8 is a flowchart for illustrating an example of the power receiving process performed in S607. The power receiving process is controlled such that the CPU 205 executes a program stored in the first memory 206.

In S801, the CPU 205 controls the close proximity wireless communication unit 204 or the wireless communication unit 214, and determines whether a request for stopping components other than hardware processing units associated with charging from the power transmission apparatus 100 is received or not. When the request for stopping the components other than the hardware processing units associated with charging is received (YES in S801), the CPU 205 proceeds from S801 to S802. When the request for stopping the components other than the hardware processing units associated with charging is not received (NO in S801), the CPU 205 proceeds from S801 to S803.

In S802, the CPU 205 controls the power supply control unit 208 to stop the components other than the hardware processing units associated with charging. For example, the instruction input unit 212 and the display unit 213 are stopped. The CPU 205 proceeds from S802 to S803.

In S803, the CPU 205 receives power from the power transmission apparatus 100 by the power supply control unit 208 via the antenna 201, the matching circuit 202, and the rectifying and smoothing circuit 203. The CPU 205 controls the power supply control unit 208 to thereby control the power supply to the components of the electronic device 200, and further controls the charge control unit 209 to thereby charge the battery 210. The CPU 205 updates the status information including the charge information, and transmits the updated status information from the close proximity wireless communication unit 204 or the wireless communication unit 214 to the power transmission apparatus 100. The CPU 205 advances the process of this flowchart from S803 to S804.

In S804, the CPU 205 controls the charge control unit 209 to acquire the charge information, and determines whether the battery 210 is in the fully charged state or not. When the battery 210 is in the fully charged state (YES in S804), the CPU 205 proceeds from S804 to S805. When the battery 210 is not in a fully charged state (NO in S804), the CPU 205 returns from S804 to S801.

In S805, the CPU 205 controls the close proximity wireless communication unit 204 or the wireless communication unit 214 to notify the power transmission apparatus 100 that the battery 210 is in the fully charged state using the charge information. The CPU 205 proceeds from S805 to S806.

In S806, the CPU 205 displays, on the display unit 213, information indicating that the charge is complete. In S806, the CPU 205 controls the LED to notify the user that the charge is complete. Then, the CPU 205 terminates the power receiving process.

Thus, according to the first exemplary embodiment, the power transmission apparatus 100 can perform both wireless power transmission and wireless communication and control which of the wireless power transmission and the wireless communication is to be performed depending on the state, etc., of the electronic device 200 (power receiving device).

### Second Exemplary Embodiment

Various functions, processes, and methods described in the first exemplary embodiment can also be implemented by a personal computer, a microcomputer, a CPU (central processing unit), or the like using a program. In a second exemplary embodiment described below, a personal computer, a microcomputer, a CPU (central processing unit), etc. is referred to as a “computer X”. In the second exemplary embodiment, a program for controlling the computer X and for implementing various functions, processes, and methods described in the first exemplary embodiment is referred to as a “program Y”.

Various functions, processes, and methods described in the first exemplary embodiment are implemented such that the computer X executes the program Y. In this case, the program Y is supplied to the computer X via a computer readable storage medium. The computer readable storage medium in the second exemplary embodiment includes at least one of a hard disk device, a magnetic storage device, an optical storage device, a magneto-optical storage device, a memory card, a volatile memory, a non-volatile memory, etc. The computer readable storage medium in the second exemplary embodiment is a non-transitory storage medium.

While aspects of the present invention are described with reference to exemplary embodiments, it is to be understood that the aspects of the present invention are not limited to the exemplary embodiments. The scope of the following claims is to be accorded the broadest interpretation so as to encompass all modifications and equivalent structures.

This application claims priority from Japanese Patent Application No. 2015-172275, filed Sep. 1, 2015, which is hereby incorporated by reference herein in its entirety.

What is claimed is:

1. A power transmission apparatus comprising:
a wireless power transmission unit that wirelessly transmits power to an electronic device;
a communication unit that performs data communication with the electronic device;
an acquisition unit that acquires status information of the electronic device from the electronic device; and
a control unit that controls, based on the acquired status information, whether data communication using the communication unit or power supply using the wireless power transmission unit is performed.

2. The power transmission apparatus according to claim 1, wherein the control unit determines whether the electronic device includes updated data, based on the acquired status information.

3. The power transmission apparatus according to claim 1, wherein the control unit determines a remaining amount of a battery, based on the acquired status information.

4. The power transmission apparatus according to claim 1, wherein the control unit controls data communication using the communication unit, when the electronic device includes updated data and a remaining amount of a battery is greater than a predetermined value.

5. The power transmission apparatus according to claim 1, wherein the control unit controls power supply using the wireless power transmission unit, when the electronic device includes no updated data.

6. The power transmission apparatus according to claim 1, wherein the control unit controls power supply using the wireless power transmission unit, when a remaining amount of a battery is less or equal to than a predetermined value.

7. A method comprising:
causing a wireless power transmission unit to wirelessly transmit power to an electronic device;
causing a communication unit to perform data communication with the electronic device;
acquiring status information of the electronic device from the electronic device; and
controlling, based on the acquired status information, whether data communication using the communication unit or power supply using the wireless power transmission unit is performed.

8. The method according to claim 7, further comprising determining, based on the acquired status information, whether the electronic device includes updated data.

9. The method according to claim 7, further comprising determining, based on the acquired status information, a remaining amount of a battery.

10. The method according to claim 7, further comprising controlling data communication using the communication unit, when the electronic device includes updated data and a remaining amount of a battery is greater than a predetermined value.

11. The method according to claim 7, further comprising controlling power supply using the wireless power transmission unit, when the electronic device includes no updated data.

12. The method according to claim 7, further comprising controlling power supply using the wireless power transmission unit, when a remaining amount of a battery is less or equal to a predetermined value.

13. A non-transitory storage medium that stores a program causing a computer to execute a method, the method comprising:
causing a wireless power transmission unit to wirelessly transmit power to an electronic device;
causing a communication unit to perform data communication with the electronic device;
acquiring status information of the electronic device from the electronic device; and
controlling, based on the acquired status information, whether data communication using the communication unit or power supply using the wireless power transmission unit is performed.
